(19) United States
(12) Patent Application Publication
(10) Pub. No.: US 2018/0213760 A1
(43) Pub. Date: Aug. 2, 2018

(54) Fish Attractant Applicator

(71) Applicant: Dwight Lewis Thrasher, Eutaw, AL (US)

(72) Inventor: Dwight Lewis Thrasher, Eutaw, AL (US)

(21) Appl. No.: 15/885,732

(22) Filed: Jan. 31, 2018

Related U.S. Application Data
(60) Provisional application No. 62/452,861, filed on Jan. 31, 2017.

(51) Int. Cl. A01K 97/00; A01K 85/01

(52) U.S. Cl. CPC A01K 97/00; A01K 85/01

(57) ABSTRACT

A fish attractant applicator retains a quantity of fish attractant to allow a fisherman to easily and efficiently apply the fish attractant onto bait. The fish attractant applicator includes a first applicator support plate, a second applicator support plate, a first applicator pad, a second applicator pad, and a support mount. The first applicator support plate and the second applicator support plate support the first applicator pad and the second applicator pad, respectively. The first applicator pad and the second applicator pad are saturated with the fish attractant. The first applicator pad is offset to the second applicator pad to allow the fisherman to insert bait between the first applicator pad and the second applicator pad to impart the fish attractant onto the bait. The support mount, in conjunction with the first applicator support plate, secures the fish attractant applicator to a support on a dock or boat.

The current application claims a priority to the U.S. Provisional Patent application Ser. No. 62/245,861 filed on Jan. 31, 2017.

### FIELD OF THE INVENTION

The present invention relates generally to a fish attractant/scent applicator. More specifically, the present invention utilizes an adjustably compression applicator for different sized baits and a fastening adaptor to couple the present invention with a foundational structure.

### BACKGROUND OF THE INVENTION

Fish attractants are utilized by fishers to increase the chances for a fish to take the bait and become lodged onto the fisherman's hook, allowing the fisherman to reel in the fish. Most fish attractants are purchased in a spray bottle container. During travel over water, the spray bottle might roll around the floor of the boat, if not secured, requiring the fisherman to search for the spray bottle, removing the fisherman's foot from actuating the trolling motor. Then the fisherman is able to apply the attractant to the bait, and start fishing. This process of reapplying the attractant can be tedious and inconvenient.

The present invention is a fish attractant applicator. The objective of the present invention is to provide an improvement on present methods of applying attractants to fishing baits. With the present invention, the fisherman can spray or soak a first applicator pad and a second applicator pad with the fish attractant. The first applicator pad and the second applicator pad will retain the attractant for several hours. The attractant is applied to bait by simply sliding the bait between the first applicator pad and the second applicator pad. The first applicator pad and the second applicator pad are mounted to a support to allow the fisherman convenient access by having the first applicator pad and the second applicator pad in a consistent position. The present invention therefore presents a definite improvement over spray bottles and other currently available methods for applying attractants. The present invention, therefore, saves time and money in a tournament fishing environment by allowing the fisherman to quickly apply attractant to the bait while reducing the total attractant wasted during application.

### BRIEF DESCRIPTION OF THE DRAWINGS

FIG. 1 is a perspective view of the present invention.

FIG. 2 is an exploded perspective view of the present invention.

FIG. 3 is a side view of the present invention.

FIG. 4 is a front view of the present invention.

FIG. 5 is a rear view of the present invention.

FIG. 6 is a top view of the present invention.

FIG. 7 is a bottom view of the present invention.

FIG. 8 is a perspective view of the present invention, wherein the present invention comprises a first mounting sleeve and a second mounting sleeve.

### DETAIL DESCRIPTIONS OF THE INVENTION

All illustrations of the drawings are for the purpose of describing selected versions of the present invention and are not intended to limit the scope of the present invention.

The present invention is a fish attractant applicator. The present invention increases the efficiency and effectively for applying an attractant to bait in order to increase the rate of catching fish. The present invention is secured to a boat such that the present invention is consistently accessible to a fisherman without limiting the fisherman from casting or reeling a fishing line.

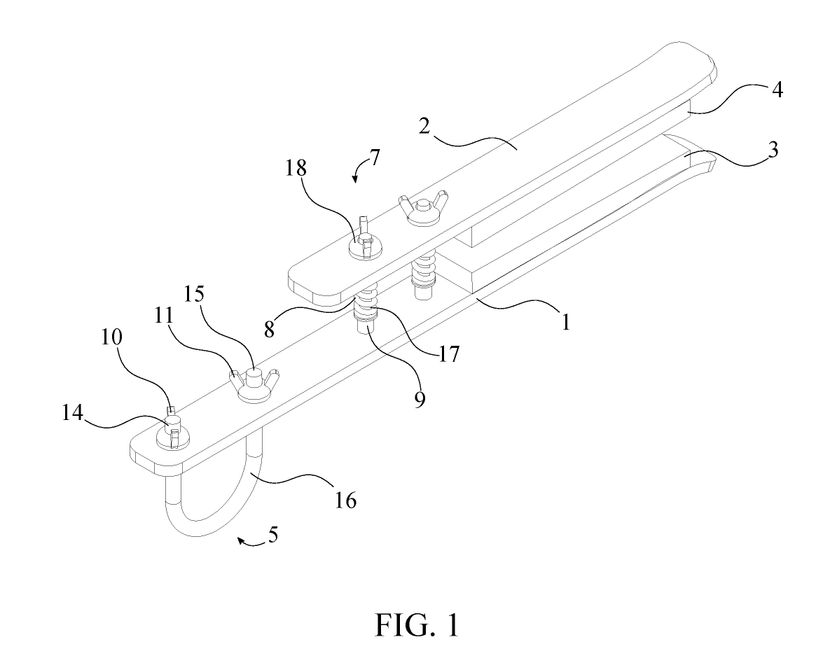

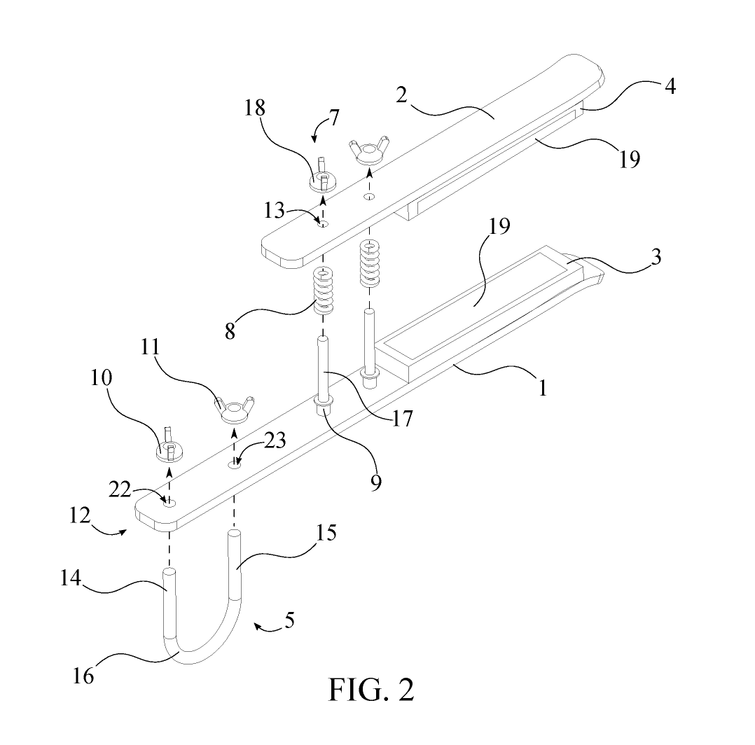

In accordance to FIG. 1, the present invention comprises a first applicator support plate 1, a second applicator support plate 2, a first applicator pad 3, a second applicator pad 4, and a support mount 5. The first applicator support plate 1 and the second applicator support plate 2 support the first applicator pad 3 and the second applicator pad 4, respectfully. The first applicator pad 3 and the second applicator pad 4 are absorbent pads that retain a quantity of fish attractant 19 during implementation of the present invention. The first applicator pad 3 is adjacently connected to the first applicator support plate 1. The second applicator pad 4 is adjacently connected to the second applicator support plate 2. Additionally, the first applicator support plate 1 comprises a pair of mounting apertures 12, detailed in FIG. 2. The first applicator support plate 1 in conjunction with the support mount 5 secures the present invention onto an appropriate support of a boat or pier. The support mount 5 is positioned through the pair of mounting apertures 12. The second applicator support plate 2 is mounted to the first applicator support plate 1, between the first applicator pad 3 and the pair of mounting apertures 12. The second applicator support plate 2 is oriented parallel to the first applicator support plate 1. The second applicator support plate 2 is oriented away from the support mount 5. The first applicator pad 3 and the second applicator pad 4 are oriented towards each other. In this configuration, the present invention is able to be mounted to the support and the fisherman is able to access the first applicator pad 3 and the second applicator pad 4 to apply the fish attractant away from the support. The fisherman applies the fish attractant to bait by sliding the bait between the first applicator pad 3 and the second applicator pad 4.

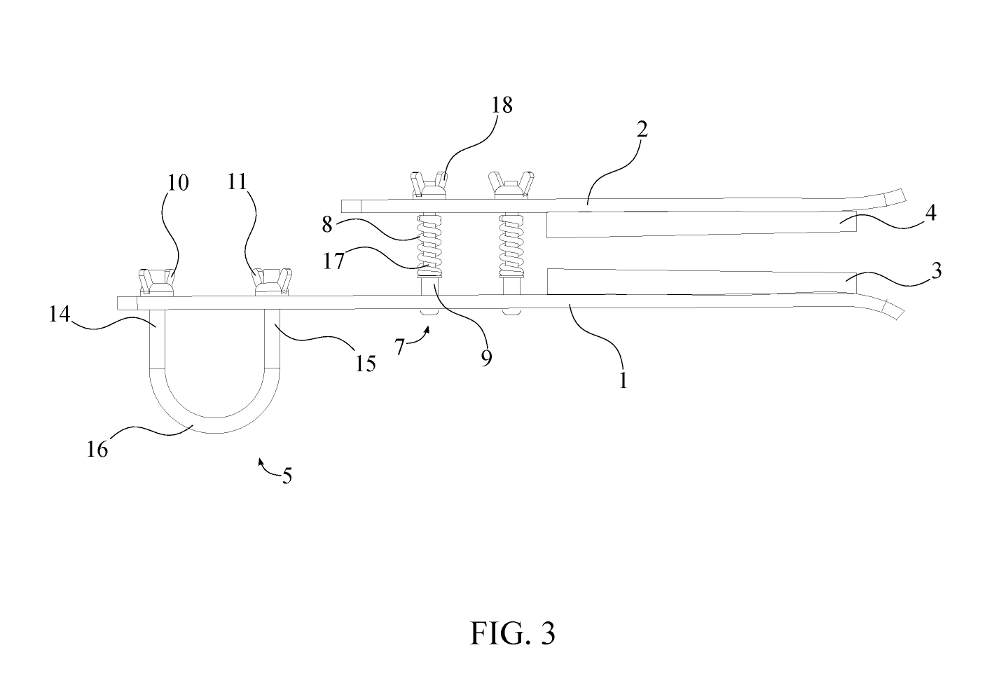

In accordance to the preferred implementation of the present invention, the second applicator pad 4 is offset from the first applicator pad 3, creating a slight gap between the first applicator pad 3 and the second applicator pad 4, shown in FIG. 3. This gap should be slightly smaller than the width of the bait to allow the bait to slide against the first applicator pad 3 and the second applicator pad 4, while imparting the fish attractant onto the bait.

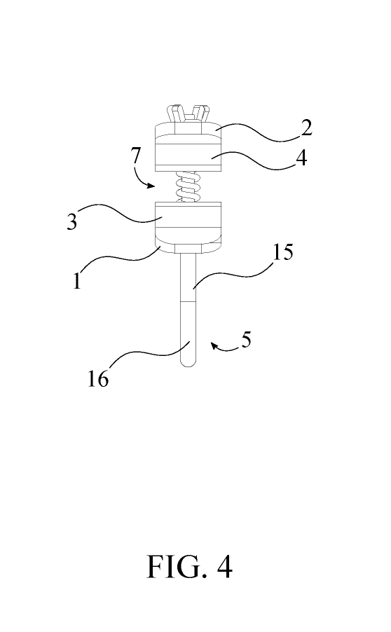

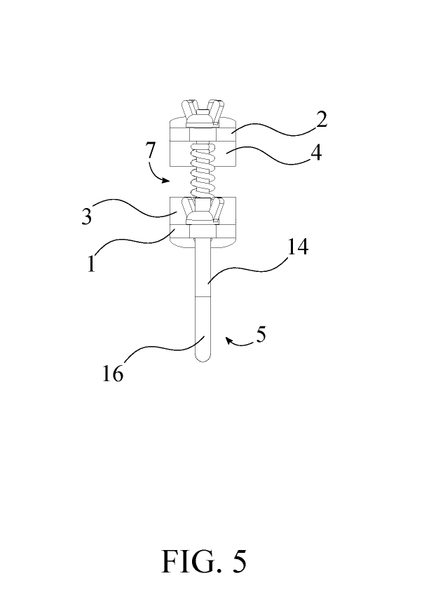

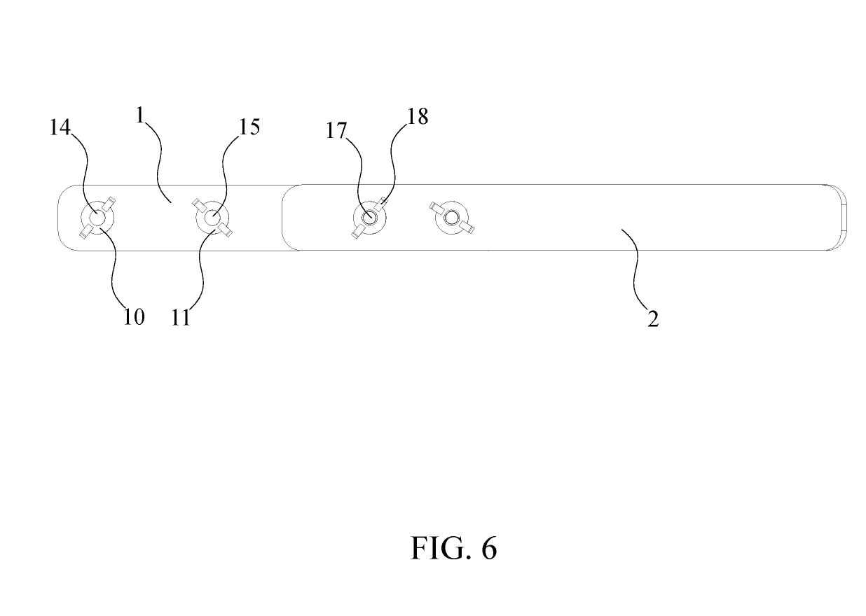

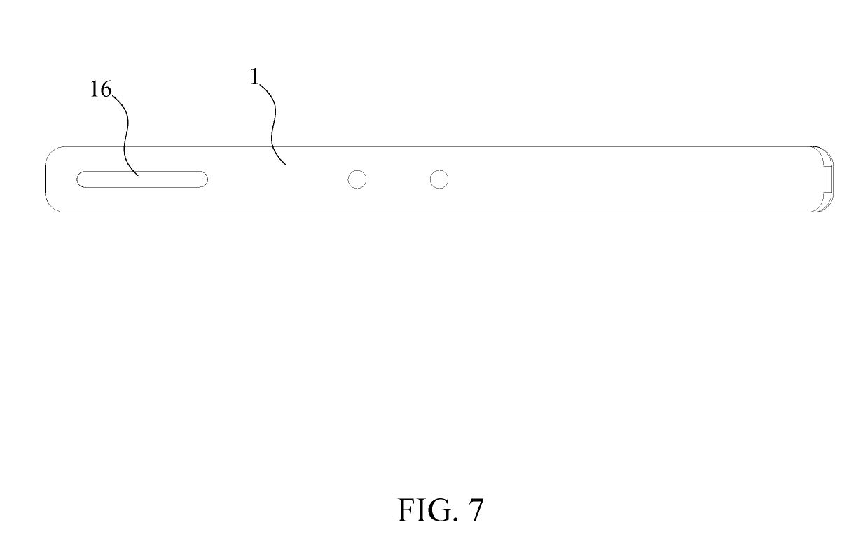

In some embodiments of the present invention, the first applicator pad 3 is adhered onto the first applicator support plate 1, detailed in FIG. 1 to FIG. 7. Adhering the first applicator pad 3 permanently affixes the first applicator pad 3 to the first applicator support plate 1. Similarly, the second applicator pad 4 is adhered onto the second applicator support plate 2. Adhering the second applicator pad 4 permanently affixes the second applicator pad 4 to the second applicator support plate 4. This configuration prevents the first applicator pad 3 and the second applicator pad 4 from being dislodged from the first applicator support plate 1 and second applicator support plate 2, respectively.

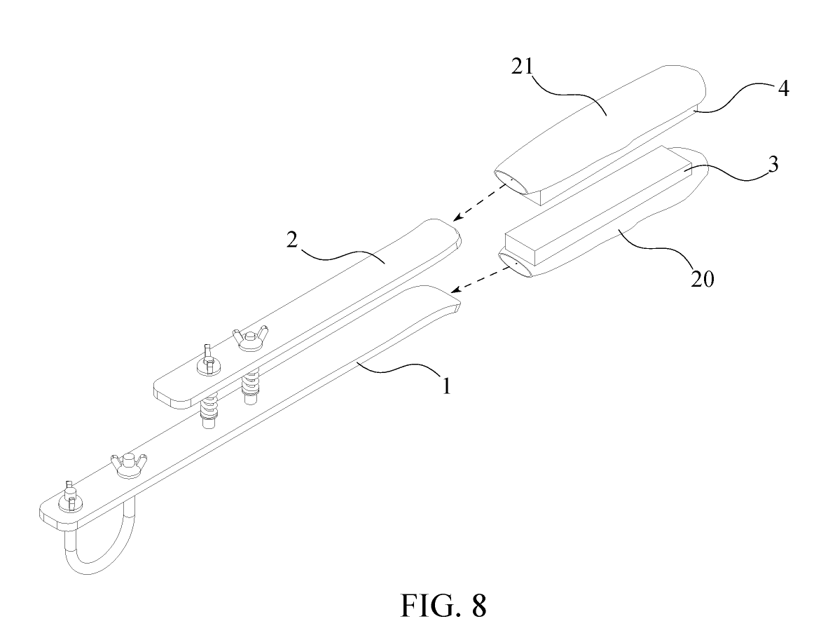

However, in accordance to the preferred embodiment, the present invention comprises a first mounting sleeve 20 and a second mounting sleeve 21, shown in FIG. 8. The first mounting sleeve 20 and the second mounting sleeve 21 allow the first applicator pad 3 and the second applicator pad 4 to be removed, respectively, in order to effectively clean the first applicator pad 3 and the second applicator pad 4. The first mounting sleeve 20 is adjacently connected to the first applicator pad 3. The first applicator support plate 1 is slideably engaged with the first mounting sleeve 20 in order to support the first applicator pad 3 during implementation of the present invention. Similarly, the second mounting sleeve 21 is adjacently connected to the second applicator pad 4. The second applicator support plate 2 is slideably engaged with the first mounting sleeve 21 in order to support the second applicator pad 4 during implementation of the present invention.

Still in accordance to the preferred embodiment of the present invention, the present invention comprises at least one distance adjustment mechanism 7, detailed in FIG. 2 and FIG. 3. The at least one distance adjustment mechanism 7 allows the fisherman to change the width of the gap between the first applicator pad 3 and the second applicator pad 4. The second applicator support plate 2 is offset from the first applicator support plate 1 by the at least one distance adjustment mechanism 7.

More specifically, the second applicator support plate 2 comprises at least one support aperture 13 that allows the second applicator support plate 2 to be mounted onto the at least one distance adjustment mechanism 7, shown in FIG. 2. Each distance adjustment mechanism 7 comprises a threaded shaft 17, that supports the second applicator support plate 2, and an adjustment threaded fastener 18, that prevents the threaded shaft 17 from sliding out of the at least one support aperture 13. The threaded shaft 17 is mounted onto the first applicator support plate 1 in order to secure the threaded shaft 17. The threaded shaft 17 is then positioned through one of the at least one support aperture 13. The adjustment threaded fastener 18 engages the threaded shaft 17. The adjustment threaded fastener 18 is positioned opposite to the first applicator support plate 1, about the second applicator support plate 2, in order to secure the second applicator support plate 2 with the first applicator support plate 1.

Further in accordance to the preferred embodiment of the present invention, the present invention comprises a tension spring 8, shown in FIG. 1 to FIG. 3. The tension spring 8 applies pressure to the first applicator support plate 1 and the second applicator support plate 2 in order to maintain the orientation of the second applicator support plate 2 and the distance between the first applicator support plate 1 and the second applicator support plate 2.

In some embodiments of the present invention, the present invention comprises a mounting collar 9, detailed in FIG. 1 to FIG. 3. The mounting collar 9 restricts the first applicator support plate 1 and the second applicator support plate 2 to a minimum distance from each other. The mounting collar 9 is adjacently connected to the first applicator support plate 1. The threaded shaft 17 is mounted to the first applicator support plate 1, with the mounting collar 9. The mounting collar 9 has a larger diameter than the at least one support aperture 13 to prevent the mounting collar 9 from being positioned within the at least one support aperture 13, and therefore, limiting how far the second applicator support plate 2 is able to slide along the threaded shaft 17. The tension spring 8 is positioned between the mounting collar 9 and the second applicator support plate 2, wherein the embodiment of the present invention comprises both the tension spring 8 and the mounting collar 9. The mounting collar 9 distributes the force of the tension spring 8 onto the first applicator support plate 1.

Still in accordance to the preferred embodiment of the present invention, the support mount 5 comprises a first threaded end 14, a second threaded end 15, and a bent shaft 16, shown in FIG. 1 to FIG. 3. The first threaded end 14 and the second threaded end 15 are positioned through the first applicator support plate 1 to secure the support mount 5 to the first applicator support plate 1. The bent shaft 16 and the first applicator support plate 1 constrict around the support to secure the present invention to the support. The first threaded end 14 and the second threaded end 15 are oppositely positioned along the bent shaft 16. The first threaded end 14 is positioned through a first aperture 22 of the pair of mounting apertures 12. Similarly, the second threaded end 15 is positioned through a second aperture 23 of the pair of mounting apertures 12. The support mount 5 is secured to the first applicator support plate 1 with a first mounting fastener 10 and a second mounting fastener 11. The first mounting fastener 10 engages the first threaded end 14. The first mounting fastener 10 is positioned opposite to the bent shaft 16 about the first applicator support plate 1. Similarly, the second mounting fastener 11 engages the second threaded end 15. The second mounting fastener 11 is positioned opposite to the bent shaft 16 about the first applicator support plate 1. The support is positioned between the bent shaft 16 and the first applicator support plate 1. The present invention is secured by constricting around the support as the first mounting fastener 10 and the second mounting fastener 11 are tightened onto the first threaded end 14 and the second threaded end 15, respectfully.

For implementation of the present invention a quantity of fish attractant 19 is necessary. The quantity of fish attractant 19 imparts pheromones onto the bait to increase a fish's attraction to the bait. The first applicator pad 3 and the second applicator pad 4 are saturated with the quantity of fish attractant 19, detailed in FIG. 2. As the fisherman slides bait past the first applicator pad 3 and the second applicator pad 4, a portion of the quantity of fish attractant 19 is imparted onto the bait.

In some embodiments of the present invention, the first applicator pad 3 is tapered away from the support mount 5, shown in FIG. 3. Similarly, the second applicator pad 4 is tapered away from the support mount 5. Tapering the first applicator pad 3 and the second applicator pad 4 allows the fisherman to easily insert the bait between the first applicator pad 3 and the second applicator pad 4.

Although the invention has been explained in relation to its preferred embodiment, it is to be understood that many other possible modifications and variations can be made without departing from the spirit and scope of the invention as hereinafter claimed.

What is claimed is:

1. A fish attractant applicator comprises:
a first applicator support plate;
a second applicator support plate;
a first applicator pad;
a second applicator pad;
a support mount;
the first applicator support plate comprises a pair of mounting apertures;
the first applicator pad being adjacently connected to the first applicator support plate;
the second applicator pad being adjacently connected to the second applicator support plate;
the support mount being positioned through the pair of mounting apertures;
the second applicator support plate being mounted to the first applicator support plate, between the first applicator pad and the pair of mounting apertures;
the second applicator support plate being oriented parallel to the first applicator support plate;
the second applicator support plate being oriented away the support mount; and
the first applicator pad and the second applicator pad being oriented towards each other.

2. The fish attractant applicator, as claimed in claim 1, comprises:
the second applicator pad being offset from the first applicator pad.

3. The fish attractant applicator, as claimed in claim 1, comprises:
the first applicator pad being adhered to the first applicator support plate.

4. The fish attractant applicator, as claimed in claim 1, comprises:
the second applicator pad being adhered to the second applicator support plate.

5. The fish attractant applicator, as claimed in claim 1, comprises:
a first mounting sleeve;
the first mounting sleeve being adjacently connected to the first applicator pad; and
the first applicator support plate being slideably engaged with the first mounting sleeve.

6. The fish attractant applicator, as claimed in claim 1, comprises:
a second mounting sleeve;
the second mounting sleeve being adjacently connected to the second applicator pad; and
the second applicator support plate being slideably engaged with the second mounting sleeve.

7. The fish attractant applicator, as claimed in claim 1, comprises:
at least one distance adjustment mechanism; and
the second applicator support plate being offset from the first applicator support plate by the at least one distance adjustment mechanism.

8. The fish attractant applicator, as claimed in claim 7, comprises:
the second applicator support plate comprises at least one support aperture;
each distance adjustment mechanism comprises a threaded shaft and an adjustment threaded fastener;
the threaded shaft being mounted to the first applicator support plate;
the threaded shaft being positioned through one of the at least one support aperture;
the adjustment threaded fastener engaging the threaded shaft; and
the adjustment threaded fastener being positioned opposite to the first applicator support plate, about the second applicator support plate.

9. The fish attractant applicator, as claimed in claim 8, comprises:
a tension spring;
the threaded shaft being positioned through the tension spring; and
the tension spring being positioned between the first applicator support plate and the second applicator support plate.

10. The fish attractant applicator, as claimed in claim 8, comprises:
a mounting collar;
the mounting collar being adjacently connected to the first applicator support plate; and
the threaded shaft being mounted to the first applicator support plate, with the mounting collar.

11. The fish attractant applicator, as claimed in claim 1, comprises:
the support mount comprises a first threaded end, a second threaded end and a bent shaft;
the first threaded end and the second threaded end being oppositely positioned along the bent shaft;
the first threaded end being positioned through a first aperture of the pair of mounting apertures; and
the second threaded end being positioned through a second aperture of the pair of mounting apertures.

12. The fish attractant applicator, as claimed in claim 11, comprises:
a first mounting fastener;
the first mounting fastener engaging the first threaded end; and
the first mounting fastener being positioned opposite to the bent shaft about the first applicator support plate.

13. The fish attractant applicator, as claimed in claim 11, comprises:
a second mounting fastener;
the second mounting fastener engaging the second threaded end; and
the second mounting fastener being positioned opposite to the bent shaft about the first applicator support plate.

14. The fish attractant applicator, as claimed in claim 1, comprises:
a quantity of fish attractant; and
the first applicator pad and the second applicator pad being saturated with the quantity of fish attractant.

15. The fish attractant applicator, as claimed in claim 1, comprises:
the first applicator pad being tapered away from the support mount.

16. The fish attractant applicator, as claimed in claim 1, comprises:
the second applicator pad being tapered away from the support mount.
